(19) United States
(12) Patent Application Publication
(10) Pub. No.: US 2012/0112980 A1
(43) Pub. Date: May 10, 2012

(54) Antenna Arrangement and a Portable Radio Communication Device Comprising Such An Antenna Arrangement

(76) Inventors: Andrei Kaikkonen, Jarfalla (SE); Lena Apelskog Killander, Danderyd (SE); Mare Chacinski, Farsta (SE); Peter Lindberg, Uppsala (SE)

(21) Appl. No.: 13/288,787

(22) Filed: Nov. 3, 2011

(30) Foreign Application Priority Data
Nov. 3, 2010 (EP) 10189841.9

(51) Int. Cl. H01Q 7/00; H01Q 21/00

(52) U.S. Cl. 343/867

(57) ABSTRACT

According to various aspects, exemplary embodiments are provided of multiple-turn loop antenna arrangements or assembly. An exemplary embodiment of an antenna assembly generally includes a multiple-turn loop element arranged in a first layer and a planar element arranged in a second layer. The first and second layers are arranged in parallel and the multiple-turn loop element is arranged on top of the planar element. The multiple-turn loop element has a thickness in the order of or more than the skin depth at a first frequency band for the multiple-turn loop antenna and the planar element has a thickness in the order of or less than the skin depth at a second higher frequency band.

### CROSS REFERENCE TO RELATED APPLICATION

This patent application claims priority of European application No. 10189841.9 filed Nov. 3, 2010. The disclosure of the application identified in this paragraph is incorporated herein by reference in its entirety.

### FIELD

The present disclosure relates generally to antenna arrangements and more particularly (but not exclusively) to a multiple-turn loop antenna arrangement.

### BACKGROUND

The statements in this section merely provide background information related to the present disclosure and may not constitute prior art.

Internal antennas have been used for some time in portable radio communication devices. There are a number of advantages connected with using internal antennas compared to protruding antennas, of which can be mentioned that they are small and light, making them suitable for applications wherein size and weight are of importance, such as in mobile phones, PDA, portable computer or similar devices, smartphones, etc.

### SUMMARY

According to various aspects, exemplary embodiments are provided of multiple-turn loop antenna arrangements or assembly. An exemplary embodiment of an antenna assembly generally includes a multiple-turn loop element arranged in a first layer and a planar element arranged in a second layer. The first and second layers are arranged in parallel and the multiple-turn loop element is arranged on top of the planar element. The multiple-turn loop element has a thickness in the order of or more than the skin depth at a first frequency band for the multiple-turn loop antenna and the planar element has a thickness in the order of or less than the skin depth at a second higher frequency band.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic drawing illustrating a NFC antenna arranged in the same region as a BT/GPS antenna in a mobile phone.

FIG. 2 is a schematic drawing illustrating a multiple-turn loop antenna.

FIG. 3 is a schematic drawing illustrating a multiple-turn loop antenna arrangement according to an exemplary embodiment.

FIG. 4 is a schematic drawing illustrating layers of the multiple-turn loop antenna arrangement in FIG. 3.

FIG. 5 is a schematic drawing illustrating a multiple-turn loop antenna arrangement according to a second exemplary embodiment.

FIG. 6 is a schematic drawing illustrating layers of the multiple-turn loop antenna arrangement in FIG. 5.

FIG. 7 is a schematic drawing illustrating a multiple-turn loop antenna arrangement according to a third exemplary embodiment.

FIG. 8 is a schematic drawing illustrating a multiple-turn loop antenna arrangement according to a fourth embodiment.

Corresponding reference numerals indicate corresponding parts throughout the several views of the drawings.

### DETAILED DESCRIPTION

The following description is merely exemplary in nature and is in no way intended to limit the present disclosure, application, or uses.

The inventors hereof have recognized the following about antennas for portable radio communication devices, such as mobile phones. For example, the application of internal antennas in a mobile phone puts some constraints on the configuration of the radiating element of the antenna. In particular, the space for an internal antenna arrangement is limited in a portable radio communication device. These constraints may make it difficult to find a configuration of the antenna arrangement that provides for desired use. This is especially true for antennas intended for use with radio signals of relatively low frequencies as the desired physical length of such antennas are large compared to antennas operating with relatively high frequencies.

One specific application operating in a relatively low frequency band is the Near Field Communication (NFC) application. The NFC operating band is about 13 Megahertz (MHz). Today, a portable radio communication device is oftentimes provided with frequency operational coverage for other frequency bands than NFC, such as FM, GSM900, GSM1800, GPS, BT, WLAN, WCDMA, and GPS. Because of the limited space available for an antenna arrangement in a portable radio communication device, it desirable to add multiple functionalities to an antenna arrangement. Further, all complementary antennas, e.g., non-cellular antennas, are typically allocated to a limited region of a mobile phone. Due to the close proximity of the antennas, isolation between the antennas will generally be a problem.

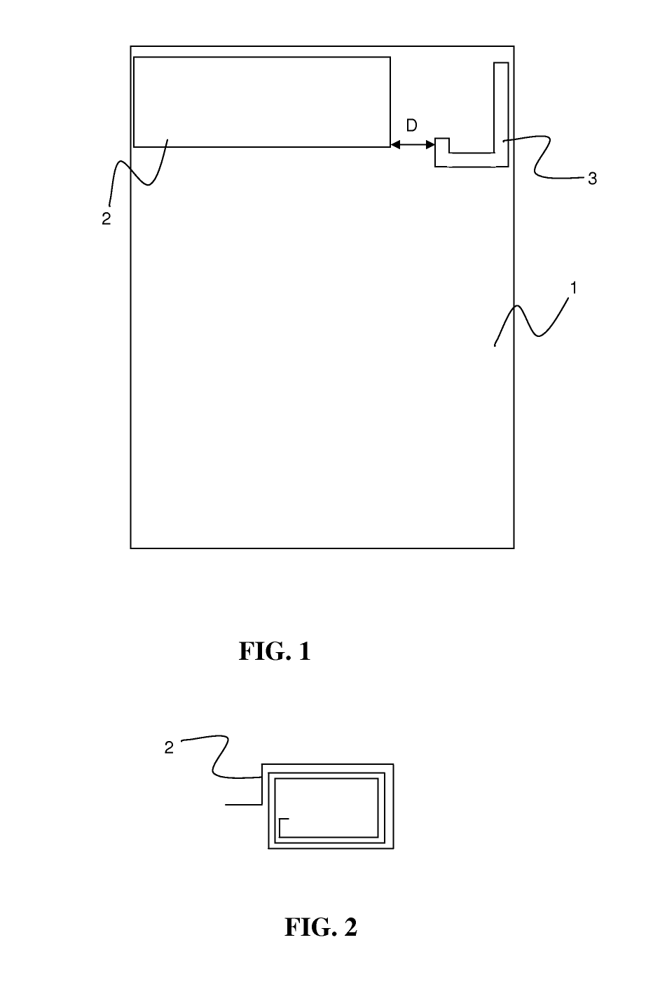

As shown in FIG. 1, a portable radio communication device, such as, for example, a mobile phone 1 typically comprises a NFC antenna 2 at or near a top end thereof. A second antenna 3, such as a BT antenna and/or a GPS antenna, is also desirable to have in the mobile phone, and is typically allocated to about the same region of the mobile phone. A NFC antenna 2 is often implemented as a multiple-turn loop antenna, which is illustrated in FIG. 2. The shortest distance D between the NFC antenna 2 and the second antenna 3 is preferably at a minimum of 5 millimeters (mm), to provide adequate isolation between the NFC antenna 2 and the GPS or BT antenna 3.

The NFC antenna would not be significantly affected by the GPS or BT antenna even if the distance D between them would be as low as 1 mm. The GPS or BT antenna is, however, significantly affected by the NFC antenna if the isolation distance D is reduced below 5 mm.

Accordingly, the inventors recognized the above and herein disclose exemplary embodiments of multiple-turn loop antenna arrangements or assembly. For example, an exemplary embodiment of an antenna assembly generally includes a multiple-turn loop element arranged in a first layer and a planar element arranged in a second layer. The first and second layers are arranged in parallel and the multiple-turn loop element is arranged on top of the planar element. The multiple-turn loop element has a thickness in the order of or more than the skin depth at a first frequency band for the multiple-turn loop antenna and the planar element has a thickness in the order of or less than the skin depth at a second higher frequency band. By providing such an antenna arrangement, the multiple-turn loop element is perceived as a ground plane for the second higher frequency band.

Exemplary embodiments may provide a multiple-turn loop antenna arrangement, which does not significantly affect a close proximity second antenna having a higher frequency band than the multiple-turn loop antenna. This advantage, among others, may be attained by a multiple-turn loop antenna arrangement and a portable radio communication device as disclosed herein.

In an exemplary embodiment, the planar element comprises a surface facing the multiple-turn loop element, wherein all turns of the multiple-turn loop element are arranged within the surface of the planar element in order to provide forming of a full ground plane as perceived by the planar element.

In an alternative embodiment, the planar element comprises a surface facing the multiple-turn loop element, wherein a part of the multiple-turn loop element is arranged within the surface of the planar element and a part of the multiple-turn loop element is arranged outside the surface of the planar element, whereby the loops of the multiple-turn loop element are perceived as grounded by the planar element.

By positioning a dielectric layer between the multiple-turn loop element and the planar element, natural isolation there between at the first frequency band is achieved.

Advantageously, an exemplary embodiment of the multiple-turn loop antenna arrangement may be configured for NFC. The second frequency band is preferably much higher than the frequency band for NFC, such as for BT or GPS.

The thickness of the planar element is preferably in the order of or less than the skin depth at the second frequency band, which makes the planar element conductive at the second frequency band and works well due to the near proximity of the multiple-turn loop element.

The thickness of the planar element is preferably in the order of or less than of the skin depth at the first frequency band, which makes the planar element transparent at the first frequency band.

The thickness of the multiple-turn loop element is preferably in the order of or more than the skin depth at the first frequency band.

The planar element is preferably configured for providing resonance for the second frequency band, which saves further space.

A portable radio communication device is also provided that includes an antenna arrangement as disclosed herein. As used herein, the term radiating element is to be understood that this term is intended to cover electrically conductive elements arranged for receiving and/or transmitting radio signals.

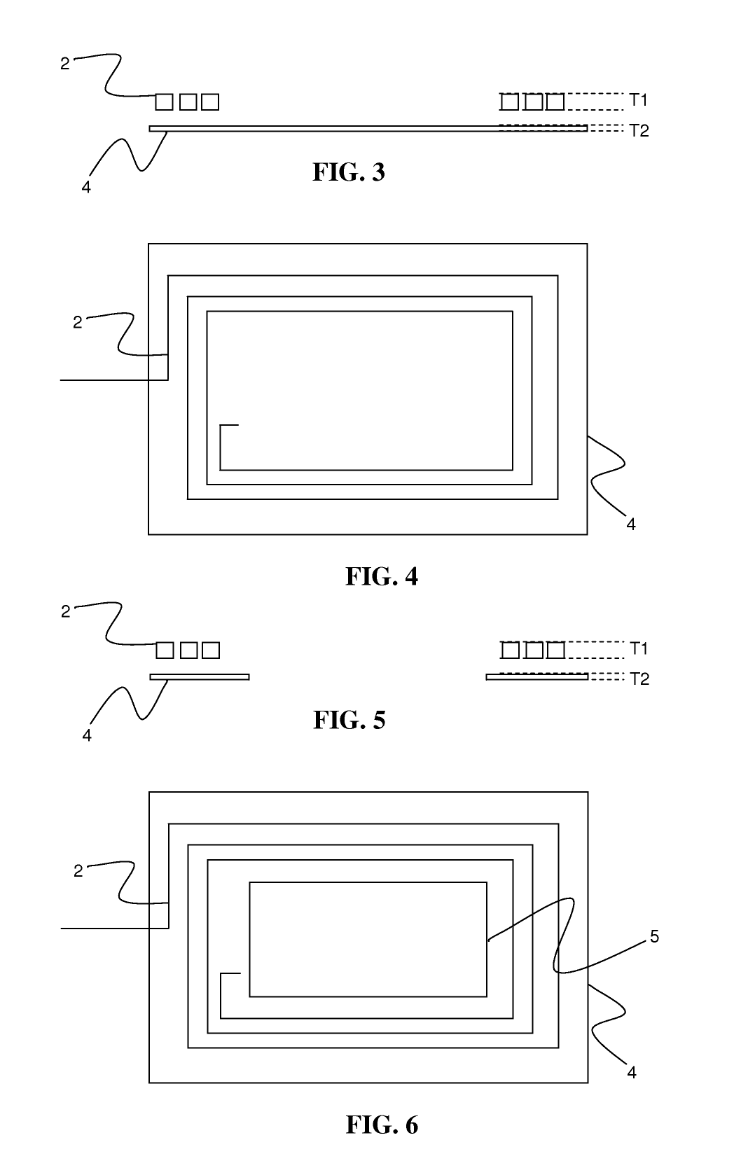

An antenna arrangement for a portable radio communication device, such as a mobile phone or similar device, according to a first embodiment will now be described with reference to FIGS. 3 and 4.

The multiple-turn loop antenna arrangement comprises a multiple-turn loop element 2 arranged in a first layer and a planar element 4 arranged in a second layer, wherein the first and second layers are arranged in parallel and the multiple-turn loop element 2 is arranged on top of the planar element 4. The multiple-turn loop element 2 has a thickness T1 in the order of or more than the skin depth at a first frequency band for the multiple-turn loop element 2 and the planar element 4 has a thickness T2 in the order of or less than the skin depth at a second higher frequency band.

For the first frequency band of e.g. an NFC antenna, the skin depth is in the order of 20 micrometer (μm). For the second higher frequency band of e.g. a BT or GPS antenna, the skin depth is in the order of 2 μm.

Even though the multiple-turn loop element 2 is described as being arranged on top of the planar element 4, the multiple-turn loop antenna arrangement can be used with the multiple-turn loop element 2 facing away from the portable radio communication device or facing towards the portable radio communication device.

The planar element 4 preferably comprises a surface facing the multiple-turn loop element 2, wherein all turns of the multiple-turn loop element 2 are arranged within the surface of the planar element 4. In this way, a nearby higher frequency band antenna perceives the multiple-turn loop antenna arrangement as a full ground plane device, and the multiple-turn loop antenna arrangement does thus not negatively couple to the nearby antenna. At the same time, the skin depth for the planar element 4 is too thin for the first frequency band to perceive it as electrically conductive and will thus not affect the performance for the multiple-turn loop element 2.

The surface of the planar element 4 may, for e.g. facilitating manufacturing of the multiple-turn loop antenna arrangement, be a full plane as shown in FIGS. 3-4. But parts of the surface of the planar element 4 not covered by the multiple-turn loop element 2, such as the inner portion of the loop, need not be present in the planar element 4, e.g. to save material costs or to allow utilization of that space for other parts of the portable radio communication device, such as a speaker or a camera. Such a form of the planar element 4 is shown in FIGS. 5-6 illustrating a second embodiment of an antenna arrangement including a multiple-turn loop element 2 and a planar element 4 without an inner portion 5. In this second embodiment, the multiple-turn loop element 2 has a thickness T1 in the order of or more than the skin depth at a first frequency band for the multiple-turn loop element 2 and the planar element 4 has a thickness T2 in the order of or less than the skin depth at a second higher frequency band.

By preferably positioning a dielectric layer between the multiple-turn loop element 2 and the planar element 4, natural isolation there between at the first frequency band is achieved.

Advantageously, the multiple-turn loop antenna arrangement is configured for NFC. The second frequency band is preferably much higher than the frequency band for NFC, such as BT, GPS, WCDMA, LTE, and/or GPS. Further, an interesting complementary frequency band is e.g. for FM. This frequency is, however, not very much higher than e.g. NFC, and the skin depth at FM is correspondingly not very much higher than for e.g. NFC. This is, however, not a problem per se, because a nearby antenna for FM is not particularly affected by the multiple-turn loop element 2 per se.

A dielectric layer arranged between the multiple-turn loop element 2 and the planar element 4 preferably has a thickness of about 50 μm, for e.g. an NFC antenna and a BT antenna.

The thickness of the planar element 4 is preferably in the order of or less than 1/10 of the skin depth at the second frequency band or even about 1/40 of the skin depth at the second frequency band for e.g. BT. This works well due to the near proximity between the multiple-turn loop element 2 and the planar element 4.

The thickness of the planar element 4 is preferably in the order of or less than 1/100 of the skin depth at the first frequency band or even about 1/400 of the skin depth at the first frequency band for e.g. NFC.

The thickness of the multiple-turn loop element 2 is preferably in the order of or more than the skin depth at the first frequency band.

The multiple-turn loop antenna arrangement is generally planar, but may e.g. be partly folded over the top edge of a mobile phone to facilitate e.g. NFC operation. The radiating elements of the multiple-turn loop antenna arrangement as well as the nearby higher frequency band antenna may be provided completely over, partially over or outside a ground plane means of the portable radio communication device.

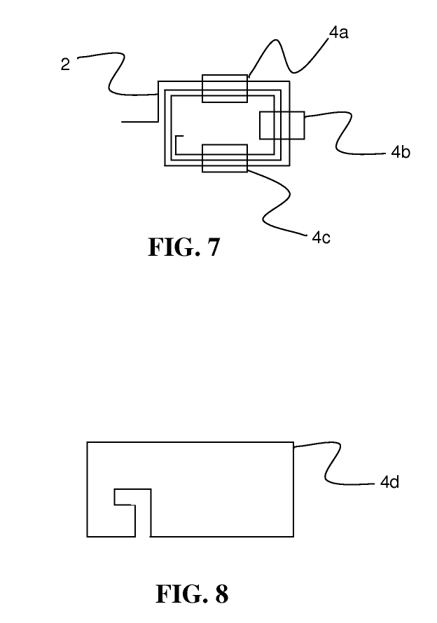

FIG. 7 illustrates a multiple-turn loop antenna arrangement or assembly according to a third embodiment. This third embodiment is identical to the first embodiment described above apart from the following.

The surface of the planar element 4a-c facing the multiple-turn loop element 2 only partly covers the multiple-turn loop element 2. The thickness of the planar element 4a-4c is in the order of or less than the multiple-turn loop element skin depth at the second frequency band. A part of the multiple-turn loop element 2 is arranged within the surface of the planar element 4a-c and a part of the multiple-turn loop element 2 is arranged outside the surface of the planar element 4a-c. Although a nearby higher frequency band antenna does not perceived the multiple-turn loop antenna arrangement as having a full ground plane device by the planar element 4a-c, the coupling therebetween can be adequately reduced. This is mainly due to that the partial ground plane device of the loop significantly changes the electrical length perceived by a nearby higher frequency antenna.

For reduced coupling to the nearby higher frequency band antenna, the antenna arrangement preferably has a plurality of separated planar elements 4a, 4b, and 4c. Advantageous positions for partial ground plane devices are e.g. parts of the loop nearest the higher frequency band antenna.

FIG. 8 illustrates a multiple-turn loop antenna arrangement or assembly according to a fourth embodiment. This fourth embodiment is identical to the first embodiment described above apart from the following. This fourth embodiment may also be combined with the features of the second embodiment described above. In the fourth embodiment, the planar element is configured for providing resonance for the second frequency band, which saves further space.

Numerical dimensions and specific materials disclosed herein are provided for illustrative purposes only. The particular dimensions and specific materials disclosed herein are not intended to limit the scope of the present disclosure, as other embodiments may be sized differently, shaped differently, and/or be formed from different materials and/or processes depending, for example, on the particular application and intended end use.

Certain terminology is used herein for purposes of reference only, and thus is not intended to be limiting. For example, terms such as “upper”, “lower”, “above”, “below”, “upward”, “downward”, “forward”, and “rearward” refer to directions in the drawings to which reference is made. Terms such as “front”, “back”, “rear”, “bottom” and “side”, describe the orientation of portions of the component within a consistent, but arbitrary, frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

Disclosure of values and ranges of values for specific parameters (such frequency ranges, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A multiple-turn loop antenna arrangement comprising a multiple-turn loop element arranged in a first layer and a planar element arranged in a second layer, wherein said first and second layers are arranged in parallel and said multiple-turn loop element is arranged on top of said planar element, and wherein said multiple-turn loop element has a thickness in the order of or more than the skin depth at a first frequency band for said multiple-turn loop element and said planar element has a thickness in the order of or less than the skin depth at a second higher frequency band.

2. The multiple-turn loop antenna arrangement according to claim 1, wherein said planar element comprises a surface facing said multiple-turn loop element, wherein all turns of said multiple-turn loop element are arranged within said surface of said planar element.

3. The multiple-turn loop antenna arrangement according to claim 1, wherein said planar element comprises a surface facing said multiple-turn loop element, wherein a part of said multiple-turn loop element is arranged within said surface of said planar element and a part of said multiple-turn loop element is arranged outside said surface of said planar element.

4. The multiple-turn loop antenna arrangement according to claim 1, comprising a dielectric layer positioned between said multiple-turn loop element and said planar element.

5. The multiple-turn loop antenna arrangement according to claim 1, wherein said first frequency band is for NFC.

6. The multiple-turn loop antenna arrangement according to claim 1, wherein said second frequency band is for BT, LTE, WCDMA, GSM or GPS.

7. The multiple-turn loop antenna arrangement according to claim 1, wherein said thickness of said planar element is in the order of or less than 1/10 of the skin depth at said second frequency band.

8. The multiple-turn loop antenna arrangement according to claim 1, wherein thickness of the multiple-turn loop element is in the order of or more than the skin depth at the first frequency band.

9. The multiple-turn loop antenna arrangement according to claim 1, wherein said planar element is configured for providing resonance for said second frequency band.

10. A portable radio communication device including the multiple-turn loop antenna arrangement according to claim 1.
